(19) United States
(12) Patent Application Publication
(10) Pub. No.: US 2021/0191165 A1
(43) Pub. Date: Jun. 24, 2021

(54) LIGHT MODULATOR, OPTICAL OBSERVATION DEVICE, AND LIGHT IRRADIATION DEVICE

(71) Applicant: HAMAMATSU PHOTONICS K.K., Hamamatsu-shi, Shizuoka (JP)

(72) Inventors: Kuniharu TAKIZAWA, Hamamatsu-shi, Shizuoka (JP); Hiroshi TANAKA, Hamamatsu-shi, Shizuoka (JP); Haruyoshi TOYODA, Hamamatsu-shi, Shizuoka (JP); Yasushi OHBAYASHI, Hamamatsu-shi, Shizuoka (JP); Hiroto SAKAI, Hamamatsu-shi, Shizuoka (JP); Tsubasa WATANABE, Hamamatsu-shi, Shizuoka (JP)

(73) Assignee: HAMAMATSU PHOTONICS K.K., Hamamatsu-shi, Shizuoka (JP)

(21) Appl. No.: 16/769,339

(22) PCT Filed: Dec. 5, 2017
(86) PCT No.: PCT/JP2017/043707

§ 371 Date: Jun. 3, 2020

(51) Int. Cl. G02F 1/03

(52) U.S. Cl. CPC G02F 1/0316; G02F 2201/08; G02F 2201/58; G02F 2203/12; G02F 2201/501

(57) ABSTRACT

A light modulator includes a perovskite-type electro-optic crystal having an input surface to which input light is input and a rear surface opposing the input surface, a first optical element being disposed on the input surface of the electro-optic crystal and having a first electrode through which the input light is transmitted, a second optical element being disposed on the rear surface of the electro-optic crystal and having a second electrode through which the input light is transmitted, and a drive circuit applying an electric field between the first electrode and the second electrode.

### TECHNICAL FIELD

The present disclosure relates to a light modulator, an optical observation device, and a light irradiation device.

### BACKGROUND ART

For example, Patent Literature 1 and Patent Literature 2 disclose electro-optical elements. These electro-optical elements include a substrate, a KTN (KTa₁₋ₓNbₓO₃) layer of a ferroelectric substance laminated on the substrate, a transparent electrode disposed on a front surface of the KTN layer, and a metal electrode disposed on a back surface of the KTN layer. KTN exhibits four crystal structures depending on a temperature and is utilized as an electro-optical element when it has a perovskite-type crystal structure. Such a KTN layer is formed on a seed layer which is formed on a metal electrode.

### CITATION LIST

### Patent Literature

[Patent Literature 1] Japanese Unexamined Patent Publication No. 2014-89340
[Patent Literature 2] Japanese Unexamined Patent Publication No. 2014-89341

### SUMMARY OF INVENTION

### Technical Problem

An electro-optical element as described above has a configuration in which a KTN layer is interposed between a pair of electrodes. In addition, the pair of electrodes are formed entirely throughout a front surface and a back surface of the KTN layer. For this reason, there is concern that when an electric field is applied to the KTN layer, an inverse piezoelectric effect or an electrostrictive effect may increase and stable light modulation may not be able to be performed. In addition, there is concern that if charge is injected into a KTN layer from a metal electrode, the modulation accuracy may not become stable due to the behavior of electrons inside a KTN crystal.

An object of the present disclosure is to provide a light modulator, an optical observation device, and a light irradiation device, in which stable light modulation can be performed.

### Solution to Problem

According to an aspect, there is provided a light modulator modulating input light and outputting modulated modulation light. The light modulator includes a perovskite-type electro-optic crystal having an input surface to which the input light is input and a rear surface opposing the input surface, and having a relative dielectric constant of 1,000 or higher; a first optical element being disposed on the input surface side of the electro-optic crystal and having a first electrode through which the input light is transmitted; a second optical element being disposed on the rear surface side of the electro-optic crystal and having a second electrode through which the input light is transmitted; and a drive circuit applying an electric field between the first electrode and the second electrode. The first electrode is disposed alone on the input surface side. The second electrode is disposed alone on the rear surface side. At least one of the first electrode and the second electrode partially covers the input surface or the rear surface. A propagation direction of the input light and an applying direction of the electric field in the electro-optic crystal are parallel to each other. At least one of the first optical element and the second optical element includes a charge injection curbing layer for curbing injection of charge into the electro-optic crystal.

According to another aspect, there is provided a light modulator modulating input light and outputting modulated modulation light. The light modulator includes a perovskite-type electro-optic crystal having an input surface to which the input light is input and a rear surface opposing the input surface, and having a relative dielectric constant of 1,000 or higher; a first optical element being disposed on the input surface side of the electro-optic crystal and having a first electrode through which the input light is transmitted; a second optical element having a second electrode disposed on the rear surface side of the electro-optic crystal and reflecting the input light toward the input surface; and a drive circuit applying an electric field between the first electrode and the second electrode. The first electrode is disposed alone on the input surface side. The second electrode is disposed alone on the rear surface side. At least one of the first electrode and the second electrode partially covers the input surface or the rear surface. A propagation direction of the input light and an applying direction of the electric field in the electro-optic crystal are parallel to each other. At least one of the first optical element and the second optical element includes a charge injection curbing layer for curbing injection of charge into the electro-optic crystal.

In addition, according to another aspect, there is provided an optical observation device including a light source outputting the input light, the light modulator described above, an optical system irradiating a target with modulation light output from the light modulator, and a photodetector detecting light output from the target.

In addition, according to another aspect, there is provided a light irradiation device including a light source outputting the input light, the light modulator described above, and an optical system irradiating a target with modulation light output from the light modulator.

According to the light modulator, the optical observation device, and the light irradiation device described above, the input light is transmitted through the first electrode of the first optical element and is input to the input surface of the perovskite-type electro-optic crystal. This input light can be output after being transmitted through the second optical element disposed on the rear surface of the electro-optic crystal or can be output after being reflected by the second optical element. At this time, an electric field is applied between the first electrode provided in the first optical element and the second electrode provided in the second optical element. Accordingly, an electric field can be applied to the electro-optic crystal having a high relative dielectric constant, and the input light can be modulated. In this light modulator, one first electrode and one second electrode are disposed, and at least one of the first electrode and the second electrode partially covers the input surface or the rear surface. In this case, an inverse piezoelectric effect or an electrostrictive effect occurs in a part in which the first electrode and the second electrode face each other, but an inverse piezoelectric effect or an electrostrictive effect does not occur around the part. For this reason, a portion around the part in which the first electrode and the second electrode face each other functions as a damper. Accordingly, compared to a case in which the input surface and the rear surface are entirely covered by the electrodes, an inverse piezoelectric effect and an electrostrictive effect can be curbed, and occurrence of resonance or the like is curbed. In addition, since a charge injection curbing layer for curbing injection of charge into the electro-optic crystal is formed, behavior of electrons inside the electro-optic crystal can become stable. Therefore, stable light modulation can be performed.

In addition, in the aspect, the light modulator may further include a transparent substrate having a first surface facing the second optical element and a second surface serving as a surface on a side opposite to the first surface. The transparent substrate may be output the input light transmitted through the second optical element. In addition, in the aspect, the light modulator may further include a substrate having a first surface facing the second optical element. In such light modulators, even when the electro-optic crystal is formed to be thin in an optical axis direction, the electro-optic crystal can be protected from an external impact or the like.

In addition, the charge injection curbing layer may be formed in each of a part between the input surface and the first electrode and a part between the rear surface and the second electrode. According to this configuration, injection of charge into the electro-optic crystal from both the first electrode and the second electrode is curbed.

In addition, in the aspect, at least an area (μm²) of one of the first electrode and the second electrode may be 25d² or smaller when a thickness (μm) of the electro-optic crystal in the electric field applying direction of the electro-optic crystal is d. In such a light modulator, an inverse piezoelectric effect or an electrostrictive effect can be effectively reduced.

In addition, in the aspect, the area of the first electrode may be larger or smaller than the area of the second electrode. In this case, positional alignment between the first electrode and the second electrode can be easily performed.

In addition, in the aspect, the light modulator may further include a third electrode being electrically connected to the first electrode, and a fourth electrode being electrically connected to the second electrode. The third electrode and the fourth electrode may be disposed not to overlap each other with the electro-optic crystal interposed therebetween.

In addition, in the aspect, the first optical element may have the third electrode being electrically connected to the first electrode, and an insulation unit being disposed between the third electrode and the input surface and reducing an electric field generated in the third electrode. The drive circuit may apply an electric field to the first electrode via the third electrode. Since the third electrode is provided for connection with the drive circuit, the size or the position of the first electrode can be designed freely. At this time, an influence of an electric field generated in the third electrode on the electro-optic crystal can be curbed by the insulation unit.

In addition, in the aspect, one optical element may have a light reduction unit covering the input surface around the first electrode and reducing light input to the input surface from parts around the first electrode. In this case, the light reduction unit may be a reflection layer reflecting the light. In addition, the light reduction unit may be an absorption layer absorbing the light. In addition, the light reduction unit may be a blocking layer blocking the light. Accordingly, input of light from a part on the input surface where the first electrode is not formed can be curbed.

In addition, in the aspect, a dielectric multilayer film reflecting the input light may be provided in the second electrode. According to this configuration, the input light can be efficiently reflected.

In addition, in the aspect, the second electrode may reflect the input light. According to this configuration, there is no need to separately provide a reflection layer or the like on the second electrode side.

In addition, in the aspect, the electro-optic crystal may be a KTa₁₋ₓNbₓO₃ (0≤x≤1) crystal, a K_{1-y}Li_{y}Ta₁₋ₓNbₓO₃ (0≤x≤1 and 0<y<1) crystal, or a PLZT crystal. According to this configuration, an electro-optic crystal having a high relative dielectric constant can be easily realized.

In addition, in the aspect, the light modulator may further include a temperature control element for controlling a temperature of the electro-optic crystal. According to this configuration, modulation accuracy can become more stable by maintaining a uniform temperature in the electro-optic crystal.

### Effects of Invention

According to the light modulator, the optical observation device, and the light irradiation device of the embodiment, an inverse piezoelectric effect or an electrostrictive effect can be curbed, and stable light modulation can be performed.

### BRIEF DESCRIPTION OF DRAWINGS

FIG. 1 is a block diagram showing a configuration of an optical observation device according to an embodiment.

FIG. 2 is a view schematically showing a light modulator according to a first embodiment.

FIG. 3 is a view showing a relationship between crystal axes, a traveling direction of light, and an electric field in retardation modulation.

FIG. 4 is a view schematically showing a light modulator according to a second embodiment.

FIG. 5 is a view schematically showing a light modulator according to a third embodiment.

FIG. 6 is a view schematically showing a light modulator according to a fourth embodiment.

FIG. 7 is a view schematically showing a light modulator according to a fifth embodiment.

FIG. 8 is a view schematically showing a light modulator according to a sixth embodiment.

FIG. 9 is a view schematically showing a light modulator according to a seventh embodiment.

FIG. 10 is a view schematically showing a light modulator according to an eighth embodiment.

FIG. 11 is a view schematically showing a light modulator according to a ninth embodiment.

FIG. 12 is a view schematically showing a light modulator according to a tenth embodiment.

FIG. 13 is a block diagram showing a configuration of a light irradiation device according to the embodiment.

### DESCRIPTION OF EMBODIMENTS

Hereinafter, embodiments will be specifically described with reference to the drawings. For the sake of convenience, there are cases in which the same reference signs are applied to elements which are substantially the same and description thereof is omitted.

### First Embodiment

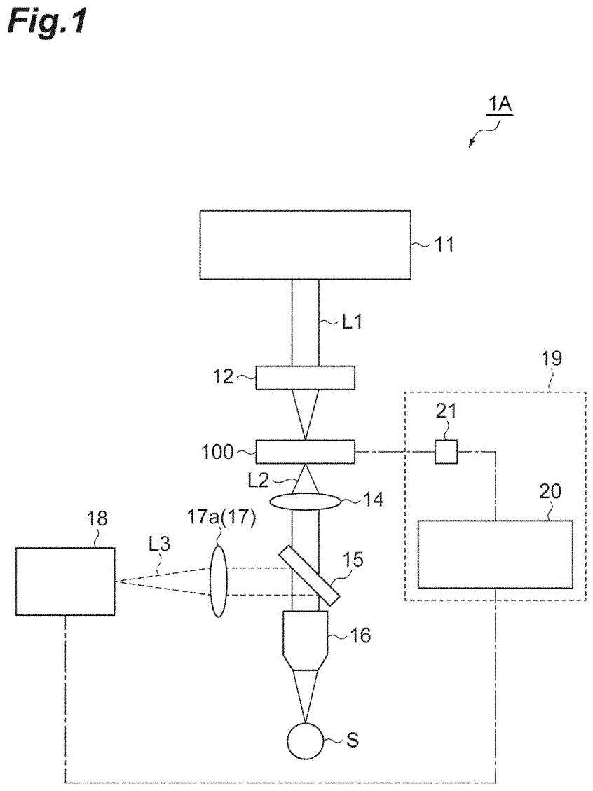

FIG. 1 is a block diagram showing a configuration of an optical observation device according to an embodiment. For example, an optical observation device 1A is a fluorescence microscope for capturing an image of an observation target. The optical observation device 1A acquires an image of a specimen (target) S by irradiating a front surface of the specimen S with input light L1 and capturing an image of detection light L3 such as fluorescence or reflected light output from the specimen S in response to the irradiation.

For example, the specimen S which becomes an observation target is a sample such as a cell or an organism including a fluorescent material such as a fluorescent dye or fluorescent protein. In addition, the specimen S may be a sample such as a semiconductor device or a film. The specimen S emits the detection light L3 such as fluorescence, for example, when irradiation with light (excitation light or illumination light) having a predetermined wavelength region is performed. For example, the specimen S is accommodated inside a holder having transmitting properties with respect to at least the input light L1 and the detection light L3. For example, this holder is held on a stage.

As shown in FIG. 1, the optical observation device 1A includes a light source 11, a concentration lens 12, a light modulator 100, a first optical system 14, a beam splitter 15, an objective lens 16, a second optical system 17, a photodetector 18, and a control unit 19.

The light source 11 outputs the input light L1 including a wavelength for exciting the specimen S. For example, the light source 11 emits coherent light or incoherent light. Examples of a coherent light source include a laser light source such as a laser diode (LD). Examples of an incoherent light source include a light emitting diode (LED), a super luminescent diode (SLD), and a lamp system light source.

The concentration lens 12 concentrates the input light L1 output from the light source 11 and outputs the concentrated input light L1. The light modulator 100 is disposed such that a propagation direction of the input light L1 and a direction of an applied electric field are parallel to each other. Therefore, in the light modulator 100, the propagation direction of the input light L1 and the applying direction of an electric field in an electro-optic crystal 101 become parallel to each other. The light modulator 100 is a light modulator modulating the phase or retardation (phase difference) of the input light L1 output from the light source 11. The light modulator 100 modulates the input light L1 input from the concentration lens 12 and outputs modulated modulation light L2 toward the first optical system 14. In the present embodiment, the light modulator 100 is constituted as a transmitting type. However, a reflective light modulator may be used in the optical observation device 1A. The light modulator 100 is electrically connected to a controller 21 of the control unit 19 and constitutes a light modulator unit. Driving of the light modulator 100 is controlled by the controller 21 of the control unit 19. Details of the light modulator 100 will be described below.

The first optical system 14 optically joins the light modulator 100 and the objective lens 16 to each other. Accordingly, the modulation light L2 output from the light modulator 100 is optically guided to the objective lens 16. For example, the first optical system 14 concentrates the modulation light L2 from the spatial light modulator 100 at a pupil of the objective lens 16.

The beam splitter 15 is an optical element for separating the modulation light L2 and the detection light L3 from each other. For example, the beam splitter 15 allows the modulation light L2 having an excitation wavelength to be transmitted therethrough and reflects the detection light L3 having a fluorescent wavelength. In addition, the beam splitter 15 may be a polarization beam splitter or may be a dichroic mirror. Depending on optical systems (for example, the first optical system 14 and the second optical system 17) in front of and behind the beam splitter 15 or the kind of an applied microscope, the beam splitter 15 may reflect the modulation light L2 and may allow the detection light L3 having a fluorescent wavelength to be transmitted therethrough.

The objective lens 16 concentrates the modulation light L2 modulated by the light modulator 100, irradiates the specimen S with the concentrated light, and optically guides the detection light L3 emitted from the specimen S in response to the irradiation. For example, the objective lens 16 is configured to be able to be moved along an optical axis by a driving element such as a piezo-actuator or a stepping motor. Accordingly, a concentration position of the modulation light L2 and a focal position for detecting the detection light L3 can be adjusted.

The second optical system 17 optically joins the objective lens 16 and the photodetector 18 to each other. Accordingly, an image of the detection light L3 optically guided from the objective lens 16 is formed by the photodetector 18. The second optical system 17 has a lens 17a for forming an image of the detection light L3 from the objective lens 16 on a light receiving surface of the photodetector 18.

The photodetector 18 captures an image of the detection light L3 which is optically guided by the objective lens 16 and of which an image is formed on the light receiving surface. For example, the photodetector 18 is an area image sensor such as a CCD image sensor or a CMOS image sensor.

The control unit 19 includes a computer 20 which includes a control circuit such as a processor, an image processing circuit, a memory, and the like; and the controller 21 which includes a control circuit such as a processor, a memory, and the like and is electrically connected to the light modulator 100 and the computer 20. For example, the computer 20 is a personal computer, a smart device, a microcomputer, a cloud server, or the like. The computer 20 controls operation of the objective lens 16, the photodetector 18, and the like and executes various kinds of control using the processor. In addition, the controller 21 controls a phase modulation quantity or a retardation modulation quantity in the light modulator 100.

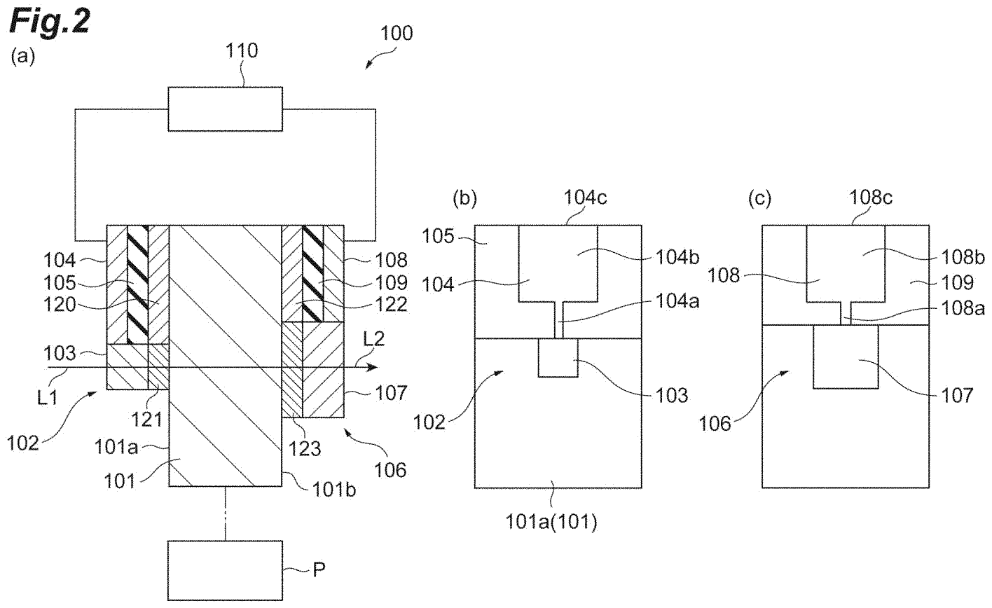

Next, the light modulator 100 will be described in detail. FIG. 2 is a view schematically showing a light modulator. The light modulator 100 is a transmitting-type light modulator modulating the input light L1 and outputting the modulated modulation light L2. As shown in FIG. 2, the light modulator 100 includes the electro-optic crystal 101, a light input unit (first optical element) 102, a light output unit (second optical element) 106, and a drive circuit 110. In FIG. 2(a), the electro-optic crystal 101, the light input unit 102, and the light output unit 106 of the light modulator 100 are shown in a cross section. In addition, FIG. 2(b) is a view of the light modulator 100 viewed from the light input unit 102 side, and FIG. 2(c) is a view of the light modulator 100 viewed from the light output unit 106 side.

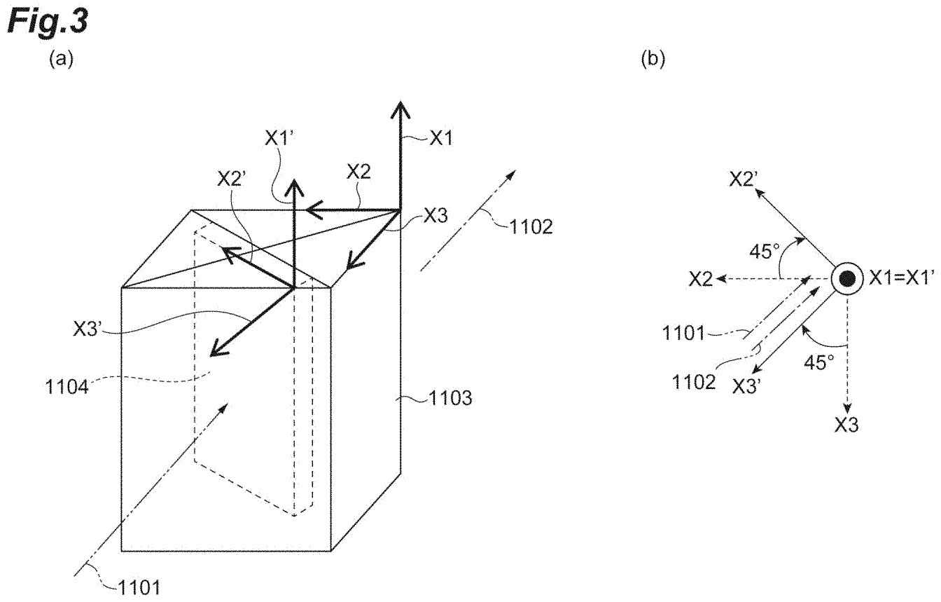

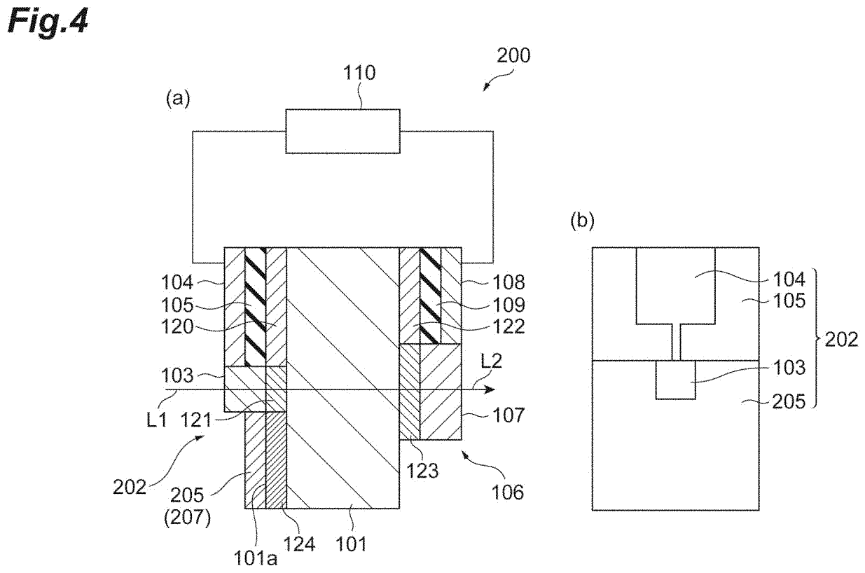

The electro-optic crystal 101 exhibits a plate shape having an input surface 101a to which the input light L1 is input and a rear surface 101b opposing the input surface 101a. The electro-optic crystal 101 has a perovskite-type crystal structure and utilizes an electro-optical effect such as a Pockels effect or a Kerr effect for changing a refractive index. The electro-optic crystal 101 having a perovskite-type crystal structure is an isotropic crystal which belongs to a point group m3m of a cubic crystal system and of which a relative dielectric constant is 1,000 or higher. For example, the relative dielectric constant of the electro-optic crystal 101 can have a value within a range of approximately 1,000 to 20,000. Examples of such an electro-optic crystal 101 include a KTa₁₋ₓNbₓO₃ (0≤x≤1) crystal (which will hereinafter be referred to as □a KTN crystal □), a K_{1-y}Li_{y}Ta₁₋ₓNbₓO₃ (0≤x≤1 and 0<y<1) crystal, and a PLZT crystal. Specifically, BaTiO₃, K₃Pb₃(Zn₂Nb₇)O₂₇, K(Ta_{0.65}Nb_{0.35})P₃, Pb₃MgNb₂O₉, Pb₃NiNb₂O₉, and the like are included. In the light modulator 100 of the present embodiment, a KTN crystal is used as the electro-optic crystal 101. Since a KTN crystal is in an m3m point group of a cubic crystal system, modulation is performed using a Kerr effect instead of a Pockels effect. For this reason, phase modulation can be performed by inputting light in a manner of being parallel or perpendicular to crystal axes of the electro-optic crystal 101 and applying an electric field in the same direction. In addition, retardation modulation can be performed when two arbitrary crystal axes are rotated about the remaining axis by an angle other than 0° and 90°. FIG. 3(a) is a perspective view showing a relationship between the crystal axes, a traveling direction of light, and an electric field in retardation modulation, and FIG. 3(b) is a plan view showing each of the axes. The example in FIG. 3 shows a case in which the crystal is rotated by an angle of 45°. When the axes X2 and X3 are rotated by 45° about the axis X1 and new axes X1′, X2′, and X3′ are set, retardation modulation can be performed by inputting light in a manner of being parallel or perpendicular to these new axes. In FIG. 4, an electric field is applied in an applying direction 1102 of a crystal 1104. A propagation direction 1101 of the input light L1 becomes parallel to the applying direction 1102 of an electric field. In this case, Kerr coefficients used for modulation of the input light L1 become g11, g12, and g44.

The relative dielectric constant of a KTN crystal is likely to be affected by the temperature. For example, the relative dielectric constant becomes approximately 20,000 which is the largest at a temperature in the vicinity of −5° C., and the relative dielectric constant falls to approximately 5,000 at a temperature near 20° C. which is a normal temperature. Here, the electro-optic crystal 101 is controlled such that it has a temperature in the vicinity of −5° C. by a temperature control element P such as a Peltier element, for example.

As shown in FIG. 2, the light input unit 102 includes a transparent electrode (first electrode) 103, a charge injection curbing layer 121, an intermediate layer 120, a connection electrode (third electrode) 104, and an insulation unit 105.

The transparent electrode 103 is disposed on the input surface 101a side of the electro-optic crystal 101. For example, the transparent electrode 103 is formed of indium tin oxide (ITO) and allows the input light L1 to be transmitted therethrough. That is, the input light L1 is transmitted through the transparent electrode 103 and is propagated toward the electro-optic crystal 101. In the present embodiment, for example, the transparent electrode 103 exhibits a rectangular shape in a plan view and partially covers the input surface 101a. In addition, the area (μm²) of the transparent electrode 103 may be 25d² or smaller when the thickness of the electro-optic crystal 101 in the electric field applying direction is d (μm). The transparent electrode 103 is formed alone at a place substantially at the center on the input surface 101a and is distanced from a circumferential edge on the input surface 101a. For example, such a transparent electrode 103 can be formed through vapor deposition of ITO using a mask pattern.

The charge injection curbing layer 121 is formed between the transparent electrode 103 and the input surface 101a. For example, the charge injection curbing layer 121 has the same size as the transparent electrode 103 and exhibits a rectangular shape in a plan view. For example, the charge injection curbing layer 121 has a dielectric material in a cured product made of a non-conductive adhesive material and includes no conductive material. The term non-conductive is not limited to properties of having no conductivity and includes highly insulating properties and properties of having high electrical resistivity. That is, the charge injection curbing layer 121 has high insulating properties (high electrical resistivity) and ideally has no conductivity.

For example, an adhesive material can be formed using an optically colorless and transparent resin such as an epoxy-based adhesive. For example, the dielectric material can have a relative dielectric constant of the same degree as that of the electro-optic crystal 101, which is within a range of approximately 100 to 30,000. The dielectric material may be a powder having a particle size equal to or smaller than the wavelength of the input light L1 and can have a particle size within a range of approximately 50 nm to 3,000 nm, for example. Scattering of light can be curbed by reducing the particle size of the dielectric material. When scattering of light is taken into consideration, the particle size of the dielectric material may be 1,000 nm or smaller and may also be 100 nm or smaller. The dielectric material may be a powder of the electro-optic crystal 101. The dielectric material has no Pockels effect. As an example, the proportion of the dielectric material in a mixture of an adhesive material and a dielectric material may be approximately 50%. For example, the charge injection curbing layer 121 can be formed by coating the input surface 101a of the electro-optic crystal 101 with a mixture of an adhesive material and a dielectric material. The charge injection curbing layer 121 need only be formed in a manner corresponding to the transparent electrode 103, and there is no need to form the charge injection curbing layer 121 on the whole surface of the input surface 101a.

In addition, the charge injection curbing layer 121 may be formed of a dielectric material such as SiO₂, HfO₂, BaTiO₃, BST ((Ba, Sr)TiO₃), STO (SrTiO₃), SrTa₂O₆, Sr₂Ta₂O₇, ZnO, Ta₂O₅, SiO₂, PZT (Pb(Zr, Ti)O₃, PZTN (Pb(Zr, Ti)Nb₂O₈, PLZT ((Pb, La)(Zr, Ti)O₃, SBT (SrBi₂Ta₂O₉), SBTN (SrBi₂(Ta, Nb)₂O₉, or BTO (Bi₄Ti₃O₁₂).

The intermediate layer 120 is formed on the input surface 101a. In the present embodiment, the intermediate layer 120 comes into contact with the charge injection curbing layer 121 and is formed equally to an end edge on one side beyond the charge injection curbing layer 121 on the input surface 101a. For example, the height of the intermediate layer 120 may be approximately the same as the height of the charge injection curbing layer 121. For example, the intermediate layer 120 may be formed of the same adhesive material as the adhesive material constituting the charge injection curbing layer 121. In addition, similar to the charge injection curbing layer 121, the intermediate layer 120 may be a mixture of an adhesive material and a dielectric material. Moreover, the intermediate layer 120 may be an insulation film formed of SiO₂, HfO₂, or the like.

The insulation unit 105 is formed on the intermediate layer 120. In the present embodiment, the insulation unit 105 comes into contact with the transparent electrode 103 and is formed equally to an end edge on one side beyond the transparent electrode 103 on the intermediate layer 120. For example, the insulation unit 105 is formed to have a height lower than the height of the transparent electrode 103. For example, the insulation unit 105 is an insulation film formed of SiO₂, HfO₂, or the like. The connection electrode 104 is formed on the insulation unit 105. That is, the insulation unit 105 is disposed between the intermediate layer 120 and the connection electrode 104. Accordingly, since most of an electric field generated in the connection electrode 104 is applied to the insulation unit, the insulation unit 105 has a thickness to an extent that an electric field applied to the electro-optic crystal 101 is disregarded. When the intermediate layer 120 and the insulation unit 105 are formed of the same material, the intermediate layer 120 and the insulation unit 105 can be formed integrally.

The connection electrode 104 is electrically connected to the transparent electrode 103. The connection electrode 104 has a thin wire-shaped lead portion 104a of which one end is electrically connected to the transparent electrode 103, and a main body portion 104b which has a rectangular shape in a plan view and is electrically connected to the other end of the lead portion 104a. For example, the area of the main body portion 104b is larger than that of the transparent electrode 103. In addition, for example, the main body portion 104b extends to the circumferential edge on the input surface 101a. In the present embodiment, one side 104c of the main body portion 104b exhibiting a rectangular shape coincides with the circumferential edge on the input surface 101a of the electro-optic crystal 101. Similar to the transparent electrode 103, the connection electrode 104 may be formed of a transparent material such as ITO. In addition, other than a transparent material, the connection electrode 104 may be formed of other conductive materials not allowing the input light L1 to be transmitted therethrough. For example, the connection electrode 104 can be formed by performing vapor deposition of ITO on the insulation unit 105 using a mask pattern.

As shown in FIG. 2(c), the light output unit 106 includes a transparent electrode (second electrode) 107, a charge injection curbing layer 123, an intermediate layer 122, a connection electrode (fourth electrode) 108, and an insulation unit 109.

The transparent electrode 107 is disposed on the rear surface 101b side of the electro-optic crystal 101. Similar to the transparent electrode 103, the transparent electrode 107 is formed of ITO, for example, and the input light L1 is transmitted therethrough. That is, the input light L1 which has been input to the inside of the electro-optic crystal 101 and subjected to phase modulation or retardation modulation can be output from the transparent electrode 107 as the modulation light L2. In the present embodiment, for example, the transparent electrode 107 exhibits a rectangular shape in a plan view and partially covers the rear surface 101b. In addition, the area (μm²) of the transparent electrode 107 may be 25d² or smaller when the thickness of the electro-optic crystal 101 in the electric field applying direction is d (μm). The transparent electrode 107 is formed alone at a place substantially at the center on the rear surface 101b and is distanced from a circumferential edge on the rear surface 101b. In addition, in a plan view, the area of the transparent electrode 107 is formed to be larger than that of the transparent electrode 103. In addition, the center of the transparent electrode 107 and the center of the transparent electrode 103 substantially coincide with each other in an optical axis direction. For this reason, when viewed in the optical axis direction, the transparent electrode 103 is entirely accommodated on the inward side of the transparent electrode 107.

The charge injection curbing layer 123 is formed between the transparent electrode 107 and the rear surface 101b. For example, the charge injection curbing layer 123 has the same size as the transparent electrode 107 and exhibits a rectangular shape in a plan view. For example, the charge injection curbing layer 123 can be formed of the same material as that of the charge injection curbing layer 121.

The intermediate layer 122 is formed on the rear surface 101b. In the present embodiment, the intermediate layer 122 comes into contact with the charge injection curbing layer 123 and is formed equally to an end edge on one side beyond the charge injection curbing layer 123 on the rear surface 101b. For example, the height of the intermediate layer 122 may be approximately the same as the height of the charge injection curbing layer 123. For example, the intermediate layer 122 can be formed of the same material as that of the intermediate layer 120.

The insulation unit 109 is formed on the intermediate layer 122. In the present embodiment, the insulation unit 109 comes into contact with the transparent electrode 107 and is formed equally to an end edge on one side beyond the transparent electrode 107 on the intermediate layer 122. For example, the insulation unit 109 is formed to have a height lower than the height of the transparent electrode 107. For example, the insulation unit 109 is an insulation film formed of an insulator such as SiO₂ or HfO₂. The connection electrode 108 is formed on the insulation unit 109. That is, the insulation unit 109 is disposed between the intermediate layer 122 and the connection electrode 108. Accordingly, the insulation unit 109 insulates an electric field generated in the connection electrode 108.

The connection electrode 108 is electrically connected to the transparent electrode 107. The connection electrode 108 has a thin wire-shaped lead portion 108a of which one end is electrically connected to the transparent electrode 107, and a main body portion 108b which has a rectangular shape in a plan view and is electrically connected to the other end of the lead portion 108a. For example, the area of the main body portion 108b is larger than that of the transparent electrode 107. In addition, for example, the main body portion 108b extends to the circumferential edge on the rear surface 101b. In the present embodiment, one side 108c of the main body portion 108b exhibiting a rectangular shape coincides with the circumferential edge on the rear surface 101b of the electro-optic crystal 101. In addition, the one side 108c of the main body portion 108b does not have to coincide with a surrounding portion on the rear surface 101b of the electro-optic crystal 101. Similar to the transparent electrode 107, the connection electrode 108 may be formed of a transparent material such as ITO. In addition, other than a transparent material, the connection electrode 108 may be formed of other conductive materials not allowing the input light L1 to be transmitted therethrough. For example, the connection electrode 108 can be formed by performing vapor deposition of ITO on the insulation unit 109 using a mask pattern. For example, the area of the main body portion 108b may be substantially the same as the area of the main body portion 104b of the light input unit 102. In addition, the area of the main body portion 108b may be smaller than the area of the front surface of the transparent electrode 107.

The drive circuit 110 applies an electric field between the transparent electrode 103 and the transparent electrode 107. In the present embodiment, the drive circuit 110 is electrically connected to the connection electrode 104 and the connection electrode 108. The drive circuit 110 inputs an electrical signal to the connection electrode 104 and the connection electrode 108 and applies an electric field between the transparent electrode 103 and the transparent electrode 107. Such a drive circuit 110 is controlled by the control unit 19.

The drive circuit 110 inputs an electrical signal between the transparent electrode 103 and the transparent electrode 107. Accordingly, an electric field is applied to the electro-optic crystal 101 and the charge injection curbing layers 121 and 123 disposed between the transparent electrode 103 and the transparent electrode 107. In this case, a voltage applied by the drive circuit 110 is distributed to the electro-optic crystal 101 and the charge injection curbing layers 121 and 123. Therefore, when a voltage applied to the electro-optic crystal 101 is Vₓₜₗ, a voltage applied to the charge injection curbing layers 121 and 123 is V_{ad}, the relative dielectric constant of the electro-optic crystal 101 is εₓₜₗ, the thickness of the electro-optic crystal 101 from the input surface 101a to the rear surface 101b is dₓₜₗ, the relative dielectric constant of the charge injection curbing layers 121 and 123 is ε_{ad}, and the sum of the thicknesses of the charge injection curbing layers 121 and 123 is d_{ad}, a voltage ratio R between a voltage applied between the transparent electrode 103 and the transparent electrode 107 and a voltage applied to the electro-optic crystal 101 is expressed by the following Expression (1). For the sake of simplification of description, the charge injection curbing layer 121 and the charge injection curbing layer 123 are assumed to be formed of materials having the same relative dielectric constant.

$$\begin{matrix}[ Math . 1 ] & \\ R = \frac{{V}_{xtl}}{{V}_{xtl} + {V}_{ad}} = \frac{{ɛ}_{ad} \cdot {d}_{xtl}}{( {ɛ}_{xtl} \cdot {d}_{ad} + {ɛ}_{ad} \cdot {d}_{xtl} )} & ( 1 )\end{matrix}$$

In this manner, a voltage applied to the electro-optic crystal 101 depends on the relative dielectric constant ε_{ad} and the thicknesses d_{ad} of the charge injection curbing layers 121 and 123. For example, in the present embodiment, the light modulator 100 has a modulation performance of outputting the input light L1 obtained by modulating the modulation light L2 by one wavelength. In this case, the relative dielectric constant ε_{ad} of the charge injection curbing layers 121 and 123 is obtained as follows. First, the maximum voltage of an application voltage generated by the drive circuit 110 is referred to as Vₛₘₐₓ. In addition, it is assumed that when Vₓₜₗ is added to the electro-optic crystal 101 and V_{ad} is added to the charge injection curbing layers 121 and 123 respectively, the modulation light L2 modulated by one wavelength is output. At this time, Vₓₜₗ<Vₓₜₗ+V_{ad}≤Vₛₘₐₓ is established. Therefore, when a voltage ratio Vₓₜₗ/Vₛₘₐₓ between V₁ and Vₛₘₐₓ is Rₛ, there is a need for the voltage ratio R and the voltage ratio Rₛ to satisfy the relationship of the following Expression (2). In this case, a voltage sufficient for performing phase modulation of the input light L1 by 2π radians can be applied to the electro-optic crystal 101.

Rₛ<R (2)

Further, from Expression (1) and Expression (2), the relative dielectric constant ε_{ad} and the thicknesses d_{ad} of the charge injection curbing layers 121 and 123 satisfy the following Expression (3).

$$\begin{matrix}[ Math . 2 ] & \\ {R}_{s} < \frac{{ɛ}_{ad} \cdot {d}_{xtl}}{( {ɛ}_{xtl} \cdot {d}_{ad} + {ɛ}_{ad} \cdot {d}_{xtl} )} & ( 3 )\end{matrix}$$

From this Expression (3), the relative dielectric constant of the charge injection curbing layers 121 and 123 is obtained. That is, when Expression (3) is transformed into an expression related to the relative dielectric constant of the charge injection curbing layers 121 and 123, the following Expression (4) is derived.

$$\begin{matrix}[ Math . 3 ] & \\ {ɛ}_{ad} > ( \frac{{ɛ}_{xtl} \cdot {R}_{s}}{{d}_{xtl} \cdot ( 1 - {R}_{s} )} ) \cdot {d}_{ad} & ( 4 )\end{matrix}$$

When the relative dielectric constant of the charge injection curbing layers 121 and 123 satisfies Expression (4), an electric field sufficient for performing modulation of the input light L1 by one wavelength can be applied to the electro-optic crystal.

In addition, when a parameter in indicated by the following Expression (5) is defined using the relative dielectric constant ε_{ad} of the charge injection curbing layers 121 and 123, the thicknesses d_{ad} of the charge injection curbing layers 121 and 123, the relative dielectric constant εₓₜₗ of the electro-optic crystal 101, and the thickness d₁ of the electro-optic crystal 101, it is preferable that the parameter in satisfy m>0.3. In addition, it is more preferable that the parameter in satisfy m>3.

$$\begin{matrix}[ Math . 4 ] & \\ m = \frac{{ɛ}_{ad} \cdot {d}_{xtl}}{2 \cdot {ɛ}_{xtl} \cdot {d}_{ad}} & ( 5 )\end{matrix}$$

According to the light modulator 100 described above, the input light L1 is transmitted through the transparent electrode 103 of the light input unit 102 and is input to the input surface 101a of the perovskite-type electro-optic crystal 101. This input light L1 is output after being transmitted through the light output unit 106 disposed on the rear surface 101b of the electro-optic crystal 101. At this time, an electric field is applied between the transparent electrode 103 provided in the light input unit 102 and the transparent electrode 107 provided in the light output unit 106. Accordingly, an electric field is applied to the electro-optic crystal 101 having a high relative dielectric constant, and the input light L1 can be modulated. In this light modulator 100, the transparent electrode 103 partially covers the input surface 101a. In addition, it is preferable that the area (μm²) of the transparent electrode 103 be 25d² or smaller when the thickness of the electro-optic crystal 101 in the electric field applying direction is d (μm). In addition, the transparent electrode 107 partially covers the rear surface 101b. The area of the transparent electrode 107 (μm²) may be 25d² or smaller when the thickness of the electro-optic crystal 101 in the electric field applying direction is d (μm). In this case, an inverse piezoelectric effect or an electrostrictive effect occurs in a part in which the transparent electrode 103 and the transparent electrode 107 face each other, but an inverse piezoelectric effect or an electrostrictive effect does not occur around the part. For this reason, a portion around the part in which the transparent electrode 103 and the transparent electrode 107 face each other functions as a damper. Accordingly, compared to a case in which the input surface 101a and the rear surface 101b are entirely covered by the electrodes, an inverse piezoelectric effect or an electrostrictive effect can be curbed, and occurrence of resonance or the like is curbed. In addition, since a charge injection curbing layer for curbing injection of charge into the electro-optic crystal is formed, behavior of electrons inside the electro-optic crystal can become stable. Therefore, stable light modulation can be performed.

In addition, since the area of the transparent electrode 103 is formed to be smaller than the area of the transparent electrode 107, positional alignment between the transparent electrode 103 and the transparent electrode 107 can be easily performed.

In addition, the light input unit 102 has the connection electrode 104 which is electrically connected to the transparent electrode 103, and the insulation unit 105 which blocks an electric field generated in the connection electrode 104. In addition, the drive circuit 110 applies an electric field between the transparent electrode 103 and the transparent electrode 107 via the connection electrode 104. In this manner, since the connection electrode 104 is provided for connection with the drive circuit 110, the size, the position, or the like of the transparent electrode 103 can be designed freely. At this time, an influence of an electric field generated in the connection electrode 104 on the electro-optic crystal 101 can be curbed by the insulation unit 105. Similarly, even in the light output unit 106, the size, the position, or the like of the transparent electrode 107 can be designed freely. In addition, an influence of an electric field generated in the connection electrode 108 on the electro-optic crystal 101 can be curbed.

In addition, since the temperature control element P for controlling the temperature of the electro-optic crystal 101 is provided, a uniform temperature can be maintained in the electro-optic crystal 101.

Accordingly, modulation accuracy can become more stable. The temperature control may be performed by the temperature control element P targeting not only the electro-optic crystal 101 but also the light modulator 100 in its entirety.

### Second Embodiment

A light modulator 200 according to the present embodiment differs from the light modulator 100 of the first embodiment in that a light input unit 202 has a light reduction unit. Hereinafter, points differing from the first embodiment will be mainly described. The same reference signs are applied to elements or members which are the same, and detailed description thereof will be omitted.

FIG. 4 is a view schematically showing the light modulator 200. The light modulator 200 includes the electro-optic crystal 101, the light input unit 202, the light output unit 106, and the drive circuit 110. In FIG. 4(a), the electro-optic crystal 101, the light input unit 202, and the light output unit 106 of the light modulator 200 are shown in a cross section. In addition, FIG. 2(b) is a view of the light modulator 200 viewed from the light input unit 202 side.

As shown in FIG. 4, the light input unit 202 includes the transparent electrode 103, the connection electrode 104, the insulation unit 105, the charge injection curbing layer 121, the intermediate layer 120, an intermediate layer 124, and a light reduction layer 205.

The intermediate layer 124 is formed on a surface of the input surface 101a excluding a part in which the charge injection curbing layer 121 (transparent electrode 103) and the intermediate layer 120 (insulation unit 105) are formed. That is, the whole surface of the input surface 101a is covered by the charge injection curbing layer 121, the intermediate layer 120, and the intermediate layer 124. For example, a material for forming the intermediate layer 124 may be the same as the material for forming the intermediate layer 120.

The light reduction layer 205 is formed on the whole surface of the intermediate layer 124. The light reduction layer 205 curbs transmitting of the input light L1 into the electro-optic crystal 101. For example, the light reduction layer is formed of a material such as a black resist obtained by dispersing carbon in an epoxy-based UV cured resin.

In the present embodiment, the insulation unit 105 is formed of a material not allowing the input light L1 to be transmitted therethrough. Examples of such a material include a black resist or the like obtained by dispersing carbon in an epoxy-based UV cured resin. In this manner, the input surface 101a is covered by the light reduction layer 205 and the insulation unit 105 around the transparent electrode 103. The light reduction layer 205 and the insulation unit 105 reduce light input to the input surface 101a from a part other than the transparent electrode 103. That is, the light reduction layer 205 and the insulation unit 105 constitute a light reduction unit 207. Since such a light reduction unit 207 is included, interference or the like of the input light L1 with different light inside the electro-optic crystal 101 can be curbed. The light reduction unit 207 may be any of a reflection layer formed with a layer reflecting light, an absorption layer formed with a layer absorbing light, and a blocking layer formed with a layer blocking light. In addition, when the light reduction layer 205 and the insulation unit 105 are formed of the same material, the light reduction layer 205 and the insulation unit 105 may be formed integrally.

### Third Embodiment

A light modulator 300 according to the present embodiment differs from the light modulator 100 of the first embodiment in a configuration of a light output unit 306. Hereinafter, points differing from the first embodiment will be mainly described. The same reference signs are applied to elements or members which are the same, and detailed description thereof will be omitted.

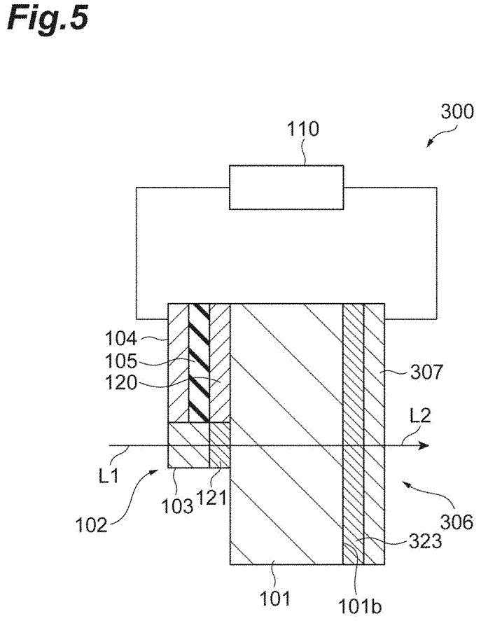

FIG. 5 is a view schematically showing the light modulator 300. The light modulator 300 includes the electro-optic crystal 101, the light input unit 102, the light output unit 306, and the drive circuit 110. In FIG. 5, the electro-optic crystal 101, the light input unit 102, and the light output unit 306 of the light modulator 300 are shown in a cross section.

The light output unit 306 includes a transparent electrode (second electrode) 307 and a charge injection curbing layer 323. The transparent electrode 307 is disposed on the rear surface 101b side of the electro-optic crystal 101. Similar to the transparent electrode 103, the transparent electrode 307 is formed of ITO, for example, and the input light L1 is transmitted therethrough. That is, the input light L1 which has been input to the inside of the electro-optic crystal 101 and subjected to phase modulation or retardation modulation can be output from the transparent electrode 307 as the modulation light L2. In the present embodiment, the transparent electrode 307 is formed on the whole surface on the rear surface 101b side.

The charge injection curbing layer 323 is formed between the transparent electrode 307 and the rear surface 101b. That is, the charge injection curbing layer 323 is formed on the whole surface of the rear surface 101b. For example, the charge injection curbing layer 323 can be formed of the same material as that of the charge injection curbing layer 123.

The drive circuit 110 is electrically connected to the connection electrode 104 and the transparent electrode 307 and applies an electric field between the transparent electrode 103 and the transparent electrode 307.

### Fourth Embodiment

A light modulator 400 according to the present embodiment differs from the light modulator 300 of the third embodiment in having the light input unit 202 in place of the light input unit 102. Hereinafter, points differing from the third embodiment will be mainly described. The same reference signs are applied to elements or members which are the same, and detailed description thereof will be omitted.

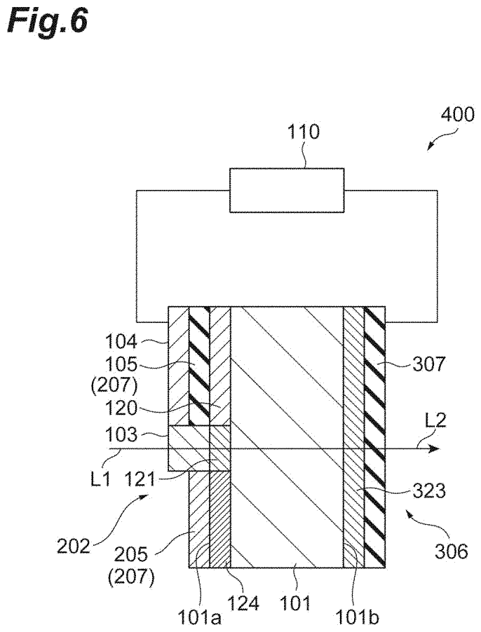

FIG. 6 is a view schematically showing the light modulator 400. The light modulator 400 includes the electro-optic crystal 101, the light input unit 202, the light output unit 306, and the drive circuit 110. In FIG. 6, the electro-optic crystal 101, the light input unit 202, and the light output unit 306 of the light modulator 400 are shown in a cross section.

As shown in FIG. 6, the light input unit 202 includes the transparent electrode 103, the connection electrode 104, the insulation unit 105, the charge injection curbing layer 121, the intermediate layer 120, the intermediate layer 124, and the light reduction layer 205. Further, similar to the second embodiment, the light reduction layer 205 and the insulation unit 105 constitute the light reduction unit 207. Accordingly, input of the input light L1 to the input surface 101a from parts other than the transparent electrode 103 can be curbed. The light reduction unit 207 may be any of a reflection layer formed with a layer reflecting light, an absorption layer formed with a layer absorbing light, and a blocking layer formed with a layer blocking light. In addition, when the light reduction layer 205 and the insulation unit 105 are formed of the same material, the light reduction layer 205 and the insulation unit 105 may be formed integrally. In addition, the drive circuit 110 is electrically connected to the connection electrode 104 and the transparent electrode 307 and applies an electric field between the transparent electrode 103 and the transparent electrode 307.

### Fifth Embodiment

A light modulator 500 according to the present embodiment differs from the light modulator 100 of the first embodiment in shape of an electro-optic crystal 501. Hereinafter, points differing from the first embodiment will be mainly described. The same reference signs are applied to elements or members which are the same, and detailed description thereof will be omitted.

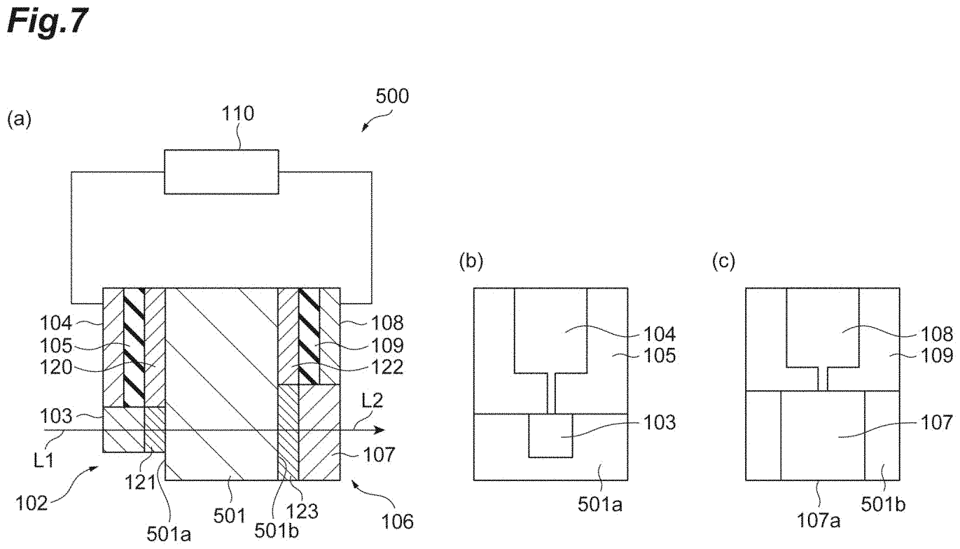

FIG. 7 is a view schematically showing the light modulator 500. The light modulator 500 includes the electro-optic crystal 501, the light input unit 102, the light output unit 106, and the drive circuit 110. In FIG. 7(a), the electro-optic crystal 501, the light input unit 102, and the light output unit 106 of the light modulator 500 are shown in a cross section. In addition, FIG. 7(b) is a view of the light modulator 500 viewed from the light input unit 102 side, and FIG. 7(c) is a view of the light modulator 500 viewed from the light output unit 106 side.

As shown in FIG. 7, the electro-optic crystal 501 exhibits a plate shape having an input surface 501a to which the input light L1 is input and a rear surface 501b opposing the input surface 501a. The electro-optic crystal 501 is made of the same material as that of the electro-optic crystal 101 of the first embodiment and is a KTN crystal, for example.

In the present embodiment, the shapes of the light input unit 102 and the light output unit 106 are the same as the shapes of those of the first embodiment, whereas the electro-optic crystal 501 is formed to have a compact shape compared to the electro-optic crystal 101 of the first embodiment. Accordingly, the transparent electrode 103 and the transparent electrode 107 are disposed in a manner of being displaced to one side (lower side in FIGS. 7(b) and 7(c)) from the centers on the input surface 101a side and the rear surface 101b side, respectively. In the shown example, a circumferential edge of the transparent electrode 103 is distanced from a circumferential edge of the input surface 501a. On the other hand, one side 107a of the transparent electrode 107 exhibiting a rectangular shape coincides with the circumferential edge on the rear surface 101b.

### Sixth Embodiment

A light modulator 600 according to the present embodiment differs from the light modulator 100 of the first embodiment in configurations of a light input unit 602 and a light output unit 606. Hereinafter, points differing from the first embodiment will be mainly described. The same reference signs are applied to elements or members which are the same, and detailed description thereof will be omitted.

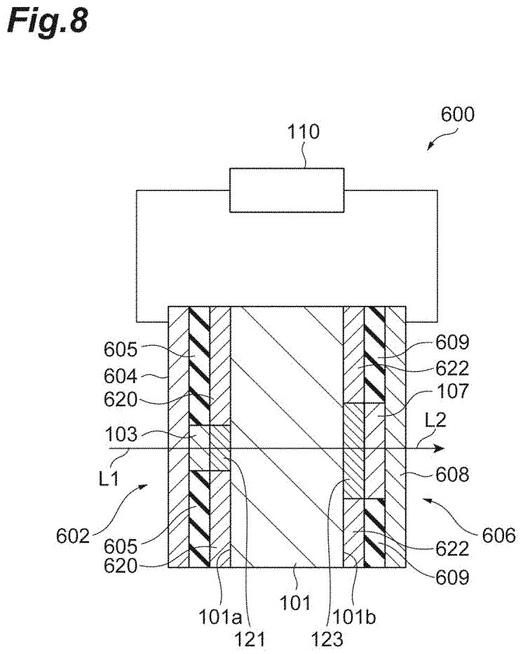

FIG. 8 is a view schematically showing the light modulator 600. The light modulator 600 includes the electro-optic crystal 101, the light input unit 602, the light output unit 606, and the drive circuit 110. In FIG. 8, the electro-optic crystal 101, the light input unit 602, and the light output unit 606 of the light modulator 600 are shown in a cross section.

As shown in FIG. 8, the light input unit 602 includes the transparent electrode 103, the charge injection curbing layer 121, an intermediate layer 620, an insulation unit 605, and a transparent connection electrode 604. The intermediate layer 620 is formed on the whole surface of the input surface 101a excluding a position where the charge injection curbing layer 121 is formed. A material for forming the intermediate layer 620 may be the same as the material for forming the intermediate layer 120.

The insulation unit 605 is formed on the whole surface of the intermediate layer 620. For example, the insulation unit 605 is an insulation film formed of an insulator such as SiO₂ or HfO₂. In addition, the insulation unit 605 may further have properties of not allowing the input light L1 to be transmitted therethrough. In this case, the insulation unit 605 can function as a light reduction unit. In the present embodiment, the insulation unit 605 is formed to have a height substantially the same as the height of the transparent electrode 103.

The transparent connection electrode 604 is formed on the whole surface of the front surfaces of the transparent electrode 103 and the insulation unit 605. Accordingly, the transparent connection electrode 604 is electrically connected to the transparent electrode 103. The input light L1 is input to the transparent electrode 103 from the transparent connection electrode 604 side. For this reason, the transparent connection electrode 604 is formed of a material through which the input light L1 is transmitted. Similar to the transparent electrode 103, the transparent connection electrode 604 may be formed of ITO, for example.

The light output unit 606 includes the transparent electrode 107, the charge injection curbing layer 123, an intermediate layer 622, an insulation unit 609, and a transparent connection electrode 608. The intermediate layer 622 is formed on the whole surface of the rear surface 101b excluding a position where the charge injection curbing layer 123 is formed. A material for forming the intermediate layer 622 may be the same as the material for forming the intermediate layer 120. The insulation unit 609 is formed on the whole surface of the intermediate layer 620. For example, the insulation unit 609 is an insulation film formed of an insulator such as SiO₂ or HfO₂. In addition, the insulation unit 609 may further have properties of not allowing the input light L1 to be transmitted therethrough. In this case, the insulation unit 609 can function as a light reduction unit. In the present embodiment, the insulation unit 609 is formed to have a height substantially the same as the height of the transparent electrode 107.

The transparent connection electrode 608 is formed on the whole surface of the front surfaces of the transparent electrode 107 and the insulation unit 609. Accordingly, the transparent connection electrode 608 is electrically connected to the transparent electrode 107. The modulation light L2 is output from the transparent electrode 107 via the transparent connection electrode 608. For this reason, the transparent connection electrode 608 is formed of a material through which the modulation light L2 is transmitted. Similar to the transparent electrode 107, the transparent connection electrode 608 may be formed of ITO, for example.

The drive circuit 110 is electrically connected to the transparent connection electrode 604 and the transparent connection electrode 608 and applies an electric field between the transparent electrode 103 and the transparent electrode 107.

### Seventh Embodiment

A light modulator 700 according to the present embodiment differs from the light modulator 600 of the sixth embodiment in that the electro-optic crystal 101 is supported by a transparent substrate 713. Hereinafter, points differing from the sixth embodiment will be mainly described. The same reference signs are applied to elements or members which are the same, and detailed description thereof will be omitted.

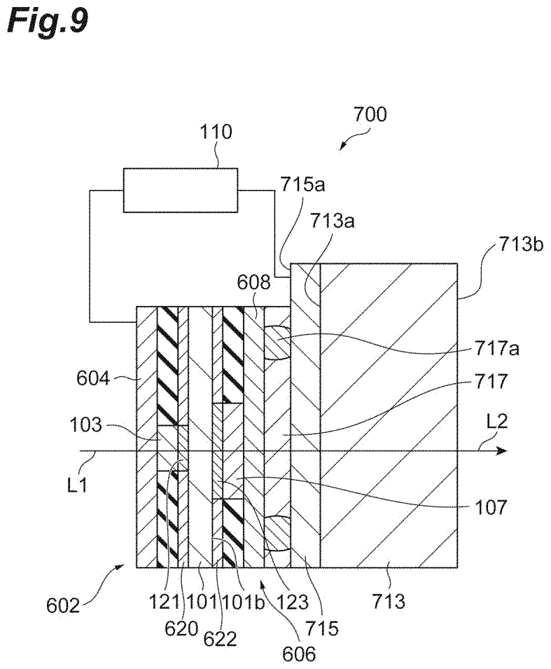

FIG. 9 is a view schematically showing the light modulator 700. The light modulator 700 includes the electro-optic crystal 101, the light input unit 602, the light output unit 606, and the drive circuit 110. In FIG. 9, the electro-optic crystal 101, the light input unit 602, and the light output unit 606 of the light modulator 700 are shown in a cross section. In the present embodiment, the thickness of the electro-optic crystal 101 in the optical axis direction can be 50 μm or smaller, for example.

The rear surface 101b side of the electro-optic crystal 101 is supported by the transparent substrate 713 through which the modulation light L2 is transmitted. For example, the transparent substrate 713 is formed of a material such as glass, quartz, or plastic in a flat plate shape. The transparent substrate 713 has an output surface (second surface) 713b outputting the modulation light L2 and an input surface (first surface) 713a serving as a surface on a side opposite to the output surface 713b and facing the light output unit 606 formed on the electro-optic crystal 101. A transparent electrode 715 formed of ITO, for example, is formed on the input surface 713a of the transparent substrate 713. The transparent electrode 715 is formed on the whole surface of the input surface 713a. The transparent electrode 715 can be formed by performing vapor deposition of ITO on the input surface 713a of the transparent substrate 713.

The transparent connection electrode 608 formed in the electro-optic crystal 101 and the transparent electrode 715 formed on the transparent substrate 713 are adhered to each other by a transparent adhesive layer 717. For example, the transparent adhesive layer 717 is formed of an epoxy-based adhesive, and the modulation light L2 is transmitted therethrough. For example, conductive members 717a such as metal spheres are disposed inside the transparent adhesive layer 717. The conductive members 717a come into contact with both the transparent connection electrode 608 and the transparent electrode 715 and electrically connect the transparent connection electrode 608 and the transparent electrode 715 to each other. For example, the conductive members 717a are disposed at four corners of the transparent adhesive layer 717 in a plan view.

In the present embodiment, the input surface 713a side of the transparent substrate 713 is formed to have a larger size than the rear surface 101b of the electro-optic crystal 101 in a plan view. For this reason, in a state in which the electro-optic crystal 101 is supported by the transparent substrate 713, a part of the transparent electrode 715 formed on the transparent substrate 713 becomes an exposed portion 715a exposed to the outside. The drive circuit 110 is electrically connected to this exposed portion 715a and the transparent connection electrode 604. That is, the drive circuit 110 is electrically connected to the transparent electrode 107 via the transparent electrode 715, the conductive members 717a, and the transparent connection electrode 608 and is electrically connected to the transparent electrode 103 via the transparent connection electrode 604. Accordingly, the drive circuit 110 can apply an electric field between the transparent electrode 103 and the transparent electrode 107.

In such a light modulator 700, phase modulation or retardation modulation can be performed more favorably by forming the electro-optic crystal 101 to be thin in the optical axis direction. When the electro-optic crystal 101 is formed to be thin in this manner, there is concern that the electro-optic crystal 101 may be damaged due to an impact or the like from the outside. In the present embodiment, since the electro-optic crystal 101 is supported by the transparent substrate 713, the electro-optic crystal 101 is protected from an external impact or the like.

### Eighth Embodiment

A light modulator 800 according to the present embodiment differs from the light modulator 100 of the first embodiment in being a reflective light modulator. When a reflective light modulator is used, it is possible to use an optical element such as a beam splitter which optically guides the input light L1 to the light modulator and optically guides the modulation light L2 modulated by the light modulator to the first optical system 14. Hereinafter, points differing from the first embodiment will be mainly described. The same reference signs are applied to elements or members which are the same, and detailed description thereof will be omitted.

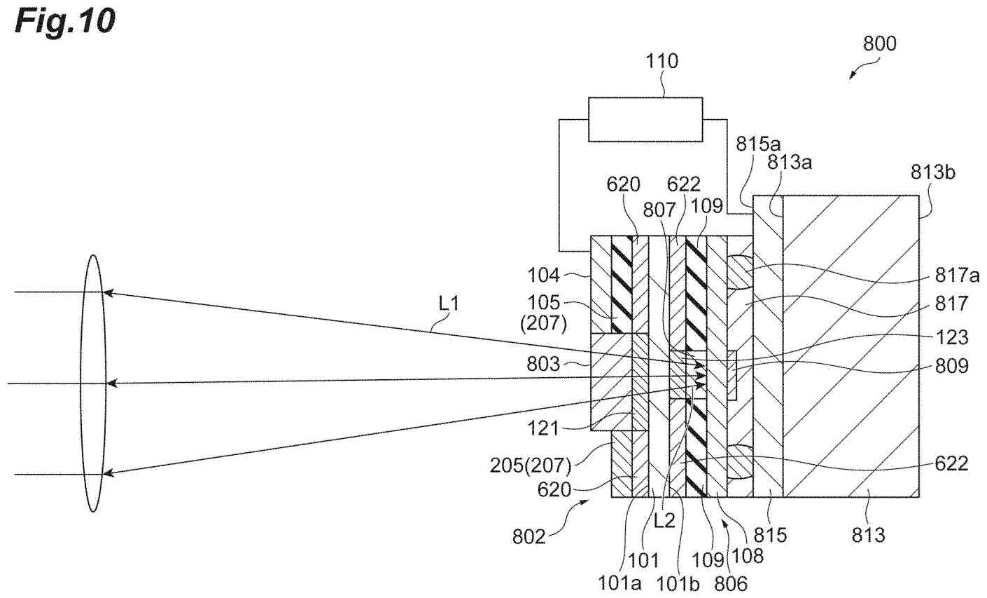

FIG. 10 is a view schematically showing the light modulator 800. The light modulator 800 is a reflective light modulator modulating the input light L1 and outputting the modulated modulation light L2. As shown in FIG. 10, the light modulator 800 includes the electro-optic crystal 101, a light input/output unit (first optical element) 802, a light reflection unit (second optical element) 806, and the drive circuit 110. In FIG. 10, the electro-optic crystal 101, the light input/output unit 802, and the light reflection unit 806 of the light modulator 800 are shown in a cross section. In the present embodiment, the thickness of the electro-optic crystal 101 in the optical axis direction can be 50 μm or smaller, for example.

The rear surface 101b side of the electro-optic crystal 101 is supported by a substrate 813. The substrate 813 is formed to have a flat plate shape. The substrate 813 has a first surface 813a facing the light reflection unit 806 bonded to the electro-optic crystal 101, and a second surface 813b serving as a surface on a side opposite to the first surface 813a. An electrode 815 is formed on the first surface 813a of the substrate 813. The electrode 815 is formed on the whole surface of the first surface 813a.

The light input/output unit 802 includes a transparent electrode (first electrode) 803, the charge injection curbing layer 121, the intermediate layer 620, the connection electrode (third electrode) 104, the insulation unit 105, and the light reduction layer 205. The transparent electrode 803 is disposed on the input surface 101a side of the electro-optic crystal 101. The transparent electrode 803 is formed of ITO, for example, and the input light L1 is transmitted therethrough. That is, the input light L1 is transmitted through the transparent electrode 803 and is input to the inside of the electro-optic crystal 101. In the present embodiment, the transparent electrode 803 is formed at a place at the center on the input surface 101a side and partially covers the input surface 101a. The area (μm²) of the transparent electrode 803 may be 25d² or smaller when the thickness of the electro-optic crystal 101 in the electric field applying direction is d (pin). For example, the transparent electrode 803 exhibits a rectangular shape in a plan view. That is, the transparent electrode 803 is distanced from the circumferential edge on the input surface 101a. For example, such a transparent electrode 803 can be formed by performing vapor deposition of ITO on the input surface 101a of the electro-optic crystal 101 using a mask pattern.

The charge injection curbing layer 121 is formed between the transparent electrode 803 and the input surface 101a. For example, the charge injection curbing layer 121 has the same size as the transparent electrode 803 and exhibits a rectangular shape in a plan view.

The light reflection unit 806 includes a transparent electrode (second electrode) 807, the charge injection curbing layer 123, the intermediate layer 622, the connection electrode (fourth electrode) 108, the insulation unit 109, and a dielectric multilayer film 809. The transparent electrode 807 is disposed on the rear surface 101b side of the electro-optic crystal 101. In the present embodiment, the transparent electrode 807 is formed at a place at the center on the rear surface 101b side and partially covers the rear surface 101b. The area (μm²) of the transparent electrode 807 may be 25d² or smaller when the thickness of the electro-optic crystal 101 in the electric field applying direction is d (unit of μm). For example, the transparent electrode 807 exhibits a rectangular shape in a plan view. That is, the transparent electrode 807 is distanced from the circumferential edge on the rear surface 101b. Similar to the transparent electrode 803, the transparent electrode 807 is formed of ITO, for example, and the input light L1 is transmitted therethrough. That is, the input light L1 which has been input to the inside of the electro-optic crystal 101 and subjected to phase modulation or retardation modulation can be transmitted through the transparent electrode 807 as the modulation light L2. In the present embodiment, the dielectric multilayer film 809 capable of efficiently reflecting light is provided on the front surface of the connection electrode 108 which is provided in the transparent electrode 807. In this case, the connection electrode 108 is a transparent electrode. The connection electrode 108 and the dielectric multilayer film 809 reflect the modulation light L2 transmitted through the transparent electrode 807 toward the transparent electrode 803 formed on the input surface 101a. For example, the dielectric multilayer film 809 can be formed by performing vapor deposition of a material such as a substance (Ta₂O₅) having a high refractive index or a substance (SiO₂) having a low refractive index on the front surface of the transparent electrode 807. In addition, the connection electrode 108 can also serve as a reflection electrode so as to reflect the modulation light L2. In this case, the dielectric multilayer film 809 is not necessary.

The charge injection curbing layer 123 is formed between the transparent electrode 807 and the rear surface 101b. For example, the charge injection curbing layer 123 has the same size as the transparent electrode 807 and exhibits a rectangular shape in a plan view.

The connection electrode 108 formed in the electro-optic crystal 101 and the electrode 815 formed on the substrate 813 are adhered to each other by an adhesive layer 817. For example, the adhesive layer 817 is formed of an epoxy-based adhesive. For example, conductive members 817a such as metal spheres are disposed inside the adhesive layer 817. The conductive members 817a come into contact with both the connection electrode 108 and the electrode 815 and electrically connect the connection electrode 108 and the electrode 815 to each other. For example, the conductive members 817a are disposed at four corners of the adhesive layer 817 in a plan view. In addition, the electrode 815 has an exposed portion 815a which is a part thereof exposed to the outside. The drive circuit 110 is electrically connected to this exposed portion 815a and the connection electrode 104.

In addition, when viewed in the optical axis direction, the area of the transparent electrode 807 is formed to be smaller than the transparent electrode 803. Further, the center of the transparent electrode 807 and the center of the transparent electrode 803 substantially coincide with each other in the optical axis direction. In this case, for example, even when the input light L1 is inclined with respect to the reflection surface of the dielectric multilayer film 809, the reflected modulation light L2 easily passes through the transparent electrode 803. In addition, as shown in FIG. 10, even when a beam waist is set to the reflection surface of the dielectric multilayer film 809, the input light L1 and the modulation light L2 easily pass through the transparent electrode 803. In addition, in the present embodiment, since the electro-optic crystal 101 is supported by the substrate 813, the electro-optic crystal 101 is protected from an external impact or the like, similar to the seventh embodiment.

### Ninth Embodiment

A light modulator 900 according to the present embodiment differs from the light modulator 100 of the first embodiment in having a light output unit 906 instead of the light output unit 106. Hereinafter, points differing from the first embodiment will be mainly described. The same reference signs are applied to elements or members which are the same, and detailed description thereof will be omitted.

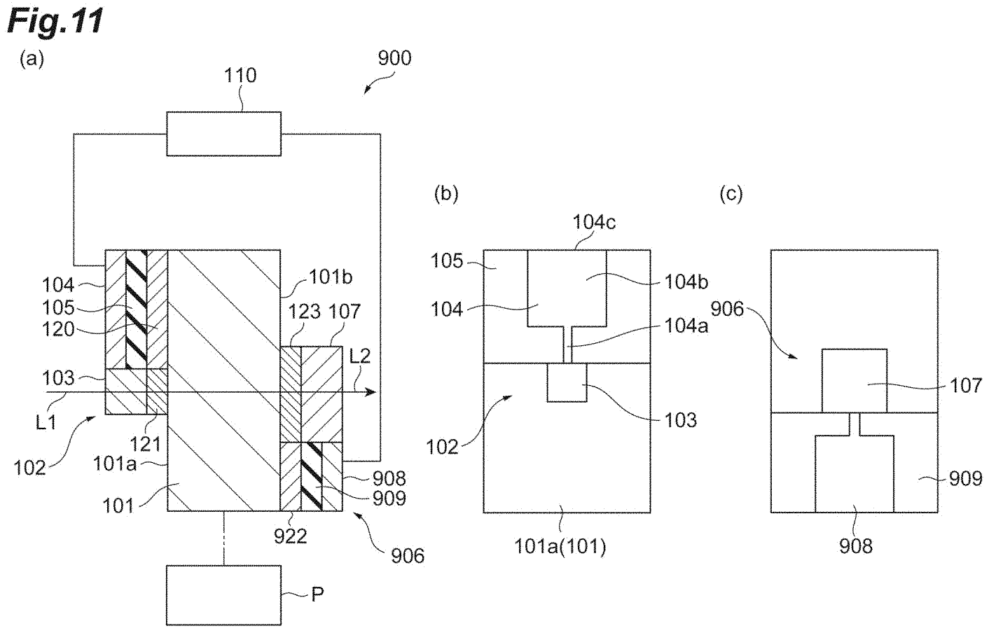

FIG. 11 is a view schematically showing the light modulator 900. The light modulator 900 includes the electro-optic crystal 101, the light input unit 102, the light output unit 906, and the drive circuit 110. In FIG. 11(a), the electro-optic crystal 101, the light input unit 102, and the light output unit 906 of the light modulator 900 are shown in a cross section. In addition, FIG. 11(b) is a view of the light modulator 900 viewed from the light input unit 102 side, and FIG. 11(c) is a view of the light modulator 900 viewed from the light output unit 906 side.

The light output unit 906 includes the transparent electrode 107, the charge injection curbing layer 123, a connection electrode 908, an intermediate layer 922, and an insulation unit 909. Similar to the connection electrode 108 in the first embodiment, the connection electrode 908 is connected to the transparent electrode 107 and the drive circuit 110. Similar to the intermediate layer 122 in the first embodiment, the intermediate layer 922 is disposed on the rear surface 101b. Similar to the insulation unit 109 in the first embodiment, the insulation unit 909 is formed on the intermediate layer 922 and is disposed between the intermediate layer 922 and the connection electrode 908.

Positions where the connection electrode 104, the insulation unit 105, and the intermediate layer 120 are disposed on the input surface 101a and positions where the connection electrode 908, the insulation unit 909, and the intermediate layer 122 are disposed on the rear surface 101b are in directions opposite to each other with respect to the transparent electrode 103 and the transparent electrode 107 when viewed in a direction along the optical axis. For this reason, the connection electrode 104, the insulation unit 105, and the intermediate layer 120; and the connection electrode 908, the insulation unit 909, and the intermediate layer 122 are displaced from each other when viewed in a direction along the optical axis and are disposed not to overlap each other with the electro-optic crystal 101 interposed therebetween. According to such a light modulator 900, effects of the insulation unit can be further enhanced. The insulation units 105 and 909 are not necessarily essential.

### Tenth Embodiment

A light modulator 1000 according to the present embodiment differs from the light modulator 100 of the first embodiment in further including transparent substrates 125 and 126. Hereinafter, points differing from the first embodiment will be mainly described. The same reference signs are applied to elements or members which are the same, and detailed description thereof will be omitted.

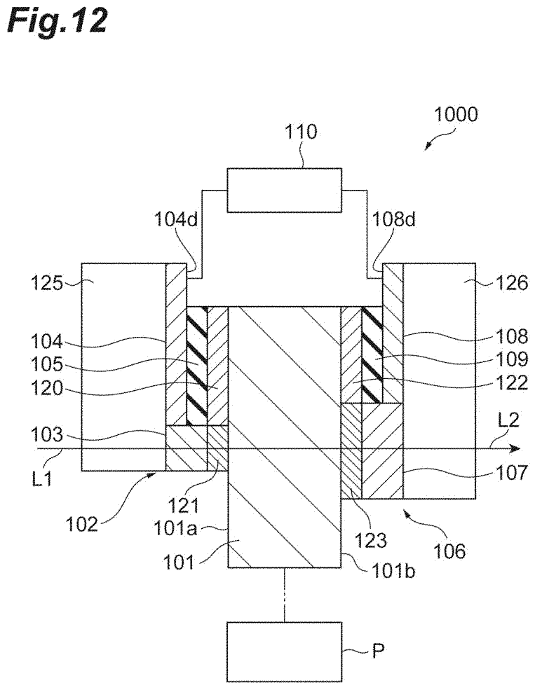

FIG. 12 is a view schematically showing the light modulator 1000. The light modulator 1000 includes the electro-optic crystal 101, the light input unit 102, the light output unit 106, the drive circuit 110, the transparent substrate 125, and the transparent substrate 126.

For example, the transparent substrate 125 is formed of a material such as glass, quartz, or plastic in a flat plate shape. The transparent substrate 125 has an input surface 125a to which the input light L1 is input and an output surface 125b serving as a surface on a side opposite to the input surface 125a and facing the input surface 101a of the electro-optic crystal 101. The transparent electrode 103 is formed and the connection electrode 104 is formed on the output surface 125b. The transparent substrate 125 protrudes beyond the end edge of the electro-optic crystal 101 in one direction intersecting the optical axis direction. Accordingly, in the present embodiment, a part of the connection electrode 104 formed on the transparent substrate 125 becomes an exposed portion 104d exposed to the outside. The drive circuit 110 is electrically connected to this exposed portion 104d.

For example, the transparent substrate 126 is formed of a material such as glass, quartz, or plastic in a flat plate shape. The transparent substrate 126 has an output surface 126a outputting the modulation light L2 and an input surface 126b serving as a surface on a side opposite to the output surface 126a and facing the rear surface 101b of the electro-optic crystal 101. The transparent electrode 107 is formed and the connection electrode 108 is formed on the input surface 126b. The transparent substrate 126 protrudes beyond the end edge of the electro-optic crystal 101 in one direction intersecting the optical axis direction. Accordingly, in the present embodiment, a part of the connection electrode 108 formed on the transparent substrate 126 becomes an exposed portion 108d exposed to the outside. The drive circuit 110 is electrically connected to this exposed portion 108d. That is, the drive circuit 110 is electrically connected to the transparent electrode 103 with the connection electrode 104 therebetween and is electrically connected to the transparent electrode 107 with the connection electrode 108 therebetween.

Also in the second embodiment to the tenth embodiment described above, similar to the first embodiment, occurrence of resonance or the like is curbed, and stable light modulation can be performed.

Hereinabove, the embodiments have been described in detail with reference to the drawings. However, specific configurations are not limited to these embodiments.

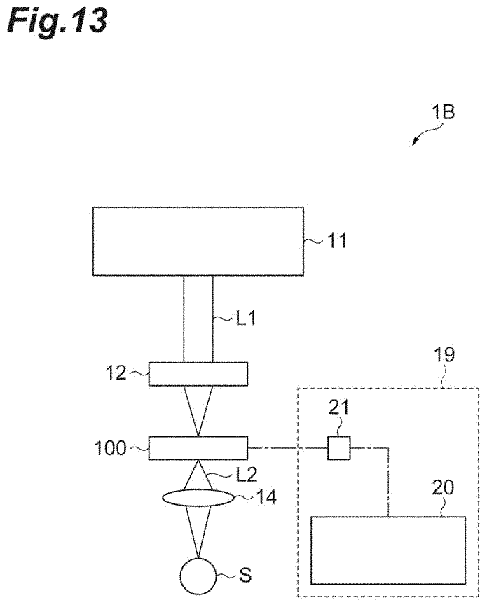

For example, in the foregoing embodiments, the optical observation device 1A including a light modulator has been exemplified, but the embodiments are not limited thereto. For example, the light modulator 100 may be mounted in a light irradiation device 1B. FIG. 13 is a block diagram showing a configuration of a light irradiation device. The light irradiation device 1B has the light source 11, the concentration lens 12, the light modulator 100, the first optical system 14, and a control unit including the computer 20 and the controller 21. In this configuration, the first optical system 14 irradiates the specimen S with the modulation light L2 output from the light modulator 100.

In the first embodiment to the seventh embodiment, the ninth embodiment, and the tenth embodiment described above, usage examples in which the input light L1 is input from a light input unit and the modulation light L2 is output from a light output unit have been described, but the embodiments are not limited thereto. For example, the input light L1 may be input from a light output unit of the light modulator, and the modulation light L2 may be output from a light input unit. In such a usage method, for example, the transparent electrode 103 corresponds to the second electrode, and the transparent electrode 107 having an area larger than that of the second electrode corresponds to the first electrode. In addition, in this case, for example, in the light modulator 200, a light reduction unit may be formed in the light output unit 106 on a side to which the input light L1 is input.

In addition, in the eighth embodiment, a configuration in which light is reflected by the dielectric multilayer film 809 formed on the front surface of the transparent electrode 807 has been exemplified, but the embodiment is not limited thereto. For example, an electrode may reflect input light by using an electrode which can reflect light in place of the transparent electrode 807. For example, input light may be reflected by an electrode formed of aluminum. According to such a configuration, there is no need to separately provide a reflection layer or the like on the second electrode side.

In addition, the configurations in the foregoing embodiments may be partially combined or substituted. For example, in the second embodiment to the eighth embodiment, the electro-optic crystal and the like may be subjected to temperature control by the temperature control element P similar to the electro-optic crystal 101 in the first embodiment.

### REFERENCE SIGNS LIST

1A Optical observation device
1B Light irradiation device
100 Light modulator
101 Electro-optic crystal
101a Input surface
101b Rear surface
102 Light input unit (first optical element)
103 Transparent electrode (first electrode)
104 Connection electrode (third electrode)
105 Insulation unit
106 Light output unit (second optical element)
107 Transparent electrode (second electrode)
110 Drive circuit
207 Light reduction unit
809 Dielectric multilayer film
L1 Input light
L2 Modulation light
P Temperature control element

1. A light modulator modulating input light and outputting modulated modulation light, the light modulator comprising:
a perovskite-type electro-optic crystal having an input surface to which the input light is input and a rear surface opposing the input surface, and having a relative dielectric constant of 1,000 or higher;
a first optical element being disposed on the input surface of the electro-optic crystal and having a first electrode through which the input light is transmitted;
a second optical element being disposed on the rear surface of the electro-optic crystal and having a second electrode through which the input light is transmitted; and
a drive circuit applying an electric field between the first electrode and the second electrode,
wherein the first electrode is disposed alone on the input surface side,
wherein the second electrode is disposed alone on the rear surface side,
wherein at least one of the first electrode and the second electrode partially covers the input surface or the rear surface,
wherein a propagation direction of the input light and an applying direction of the electric field in the electro-optic crystal are parallel to each other, and
wherein at least one of the first optical element and the second optical element includes a charge injection curbing layer for curbing injection of charge into the electro-optic crystal.

2. The light modulator according to claim 1, further comprising:
a transparent substrate having a first surface facing the second optical element and a second surface serving as a surface on a side opposite to the first surface,
wherein the transparent substrate outputs the input light transmitted through the second optical element.

3. A light modulator modulating input light and outputting modulated modulation light, the light modulator comprising:
a perovskite-type electro-optic crystal having an input surface to which the input light is input and a rear surface opposing the input surface, and having a relative dielectric constant of 1,000 or higher;
a first optical element being disposed on the input surface of the electro-optic crystal and having a first electrode through which the input light is transmitted;
a second optical element having a second electrode disposed on the rear surface of the electro-optic crystal and reflecting the input light toward the input surface; and
a drive circuit applying an electric field between the first electrode and the second electrode,
wherein the first electrode is disposed alone on the input surface side,
wherein the second electrode is disposed alone on the rear surface side,
wherein at least one of the first electrode and the second electrode partially covers the input surface or the rear surface,
wherein a propagation direction of the input light and an applying direction of the electric field in the electro-optic crystal are parallel to each other, and
wherein a charge injection curbing layer for curbing injection of charge into the electro-optic crystal is formed in at least one of a part between the input surface and the first electrode and a part between the rear surface and the second electrode.

4. The light modulator according to claim 3, further comprising:
a substrate having a first surface facing the second optical element.

5. The light modulator according to claim 1,
wherein the charge injection curbing layer is formed in each of a part between the input surface and the first electrode and a part between the rear surface and the second electrode.

6. The light modulator according to claim 1,
wherein at least an area (μm²) of one of the first electrode and the second electrode is 25d² or smaller when a thickness (μm) of the electro-optic crystal in the electric field applying direction of the electro-optic crystal is d.

7. The light modulator according to claim 1,
wherein the area of the first electrode is larger or smaller than the area of the second electrode.

8. The light modulator according to claim 1, further comprising:
a third electrode being electrically connected to the first electrode; and
a fourth electrode being electrically connected to the second electrode,
wherein the third electrode and the fourth electrode are disposed not to overlap each other with the electro-optic crystal interposed therebetween.

9. The light modulator according to claim 1,
wherein the first optical element has
a third electrode being electrically connected to the first electrode, and
an insulation unit being disposed between the third electrode and the input surface and blocking an electric field generated in the third electrode, and
wherein the drive circuit applies an electric field to the first electrode with the third electrode therebetween.

10. The light modulator according to claim 1,
wherein the first optical element has a light reduction unit covering the input surface around the first electrode and reducing light input to the input surface from parts around the first electrode.

11. The light modulator according to claim 10,
wherein the light reduction unit is a reflection layer reflecting the light.

12. The light modulator according to claim 10,
wherein the light reduction unit is an absorption layer absorbing the light.

13. The light modulator according to claim 10,
wherein the light reduction unit is a blocking layer blocking the light.

14. The light modulator according to claim 3,
wherein a dielectric multilayer film reflecting the input light is provided in the second electrode.

15. The light modulator according to claim 3,
wherein the second electrode reflects the input light.

16. The light modulator according to claim 1,
wherein the electro-optic crystal is a KTa₁₋ₓNbₓO₃ (0≤x≤1) crystal, a K_{1-y}Li_{y}Ta₁₋ₓNbₓO₃ (0≤x≤1 and 0<y<1) crystal, or a PLZT crystal.

17. The light modulator according to claim 1, further comprising:
a temperature control element for controlling a temperature of the electro-optic crystal.

18. An optical observation device comprising:
a light source outputting the input light;
the light modulator according to claim 1;
an optical system irradiating a target with modulation light output from the light modulator; and
a photodetector detecting light output from the target.

19. A light irradiation device comprising:
a light source outputting the input light;
the light modulator according to claim 1; and
an optical system irradiating a target with modulation light output from the light modulator.
